(19) United States
(12) Patent Application Publication
(10) Pub. No.: US 2025/0273748 A1
(43) Pub. Date: Aug. 28, 2025

(54) METHOD FOR ENHANCING THE SAFETY OF A METAL-ION BATTERY

(71) Applicant: National Taiwan University of Science and Technology, Taipei (TW)

(72) Inventors: Bing-Joe Hwang, Taipei (TW); Sheng-Chiang Yang, Taipei (TW); Wei-Nien Su, Taipei (TW); Shi-Kai Jiang, Taipei (TW); Kuan-Hsien Lee, Taipei (TW); Yu-Chun Huang, Taipei (TW)

(21) Appl. No.: 19/061,633

(22) Filed: Feb. 24, 2025

Related U.S. Application Data
(60) Provisional application No. 63/557,780, filed on Feb. 26, 2024.

(51) Int. Cl. H01M 10/42; H01M 4/02; H01M 4/66; H01M 10/0525; H01M 10/054

(52) U.S. Cl. CPC H01M 10/4235; H01M 4/661; H01M 10/0525; H01M 10/054; H01M 2004/027

(57) ABSTRACT

A method for enhancing the safety of a metal-ion electrochemical device comprises steps of providing a metal-ion electrochemical device that at least includes a positive electrode, a negative electrode, and a separator disposed therebetween; the negative electrode comprises a negative electrode current collector coated with a negative electrode active material, and a metal-ion-affinitive layer is positioned between the negative electrode current collector and the negative electrode active material; charging and discharging the metal-ion electrochemical device to induce the deposition of a metal-ion dendrite layer between the negative electrode active material and the metal-ion-affinitive layer. By introducing the metal-ion-affinitive layer, the present invention effectively restricts the deposition of lithium dendrites between the negative electrode current collector and the negative electrode active material under normal, overcharging, or rapid charging and discharging conditions. This significantly reduces the risk of contact and penetration of the separator by lithium metal dendrites preventing battery short circuits.

### FIELD OF INVENTION

A method for enhancing the safety of an electrochemical device, particularly to a method for enhancing the safety of a metal-ion electrochemical device.

The present invention has been developed primarily to be a method for enhancing the safety of a metal-ion electrochemical device, particularly to a lithium ion battery for describing hereinafter with references and multiple embodiments to this application. However, it will be appreciated that the present invention is not limited to this particular method, field of use or effect.

### BACKGROUND OF THE INVENTION

During charge-discharge cycling of a conventional lithium-ion batteries, as shown in FIGS. 4A and 4B, lithium dendrites deposit between the separator and the anode material. As illustrated in FIG. 4B, a tippy or pointy dendritic layer forms. This dendritic structure direct contacts with the separator, and after multiple charge-discharge cycles, it will gradually pierce the separator, leading to a short circuit in the lithium-ion battery. Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to address the issue in conventional lithium-ion batteries where lithium dendrites deposit between the separator and the anode material during charge-discharge cycling, and the tippy or pointy dendritic structure may pierce the separator, leading to a battery short circuit, the present invention provides a method for enhancing the safety of a metal-ion electrochemical device. The said method comprises steps of:
step 1: providing a metal-ion electrochemical device, which includes at least a cathode, an anode, and a separator positioned between the cathode and the anode; wherein the anode comprises an anode current collector coated with an anode active material, and a metal-ion-philic layer is positioned between the anode current collector and the anode active material;
step 2: charging and discharging the metal-ion electrochemical device; and
step 3: depositing a metal-ion dendrite layer between the anode active material and the metal-ion-philic layer.

In accordance with another prospect of the present invention, the metal-ion electrochemical device comprises a lithium-ion battery, a sodium-ion battery, a potassium-ion battery, or a dual-ion or multi-ion battery containing any of the aforementioned metal ions.

In accordance with another prospect of the present invention, the anode active material comprises carbon-based compounds, silicon or its compounds or oxides, aluminum or its compounds or oxides, germanium or its compounds or oxides, lithium titanate compounds or oxides, niobium titanate compounds or oxides, or combinations thereof.

In accordance with another prospect of the present invention, the carbon-based compounds comprise graphite or soft carbon, and the lithium titanate compounds comprise lithium titanium oxide.

In accordance with another prospect of the present invention, the anode current collector comprises copper foil, aluminum foil, nickel foil, stainless steel foil, indium foil, or combinations thereof.

In accordance with another prospect of the present invention, the metal-

ion-philic layer comprises Group 2A to Group 6A elements, as well as Group 1B to Group 6B and Group 8B elements, eg. strontium (Sr), gallium (Ga), antimony (Sb), magnesium (Mg), calcium (Ca), barium (Ba), scandium (Sc), yttrium (Y), aluminum (Al), indium (In), thallium (Tl), germanium (Ge), tin (Sn), lead (Pb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), compounds thereof, or combinations thereof.

In accordance with another prospect of the present invention, in step 2, the metal-ion electrochemical device is charged and discharged under normal or overcharging voltage and current conditions.

In accordance, the present invention has the following advantages:

The present invention enhances the safety of a lithium-ion battery by introducing a metal-ion-philic layer between the anode current collector and the anode active material. This design enables and induces lithium dendrites to deposit between the anode current collector and the anode active material (or beneath the anode active material) under normal cycling conditions, particularly during overcharging cycles. By doing so, the invention prevents lithium dendrites from piercing the separator, thereby mitigating the risk of a short circuit in the lithium-ion battery.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a schematic flowchart illustrating the steps of a preferred embodiment in accordance to the present invention.

FIG. 2 is a schematic diagram of the deposition of the metal-ion dendrite layer between the anode active material and the metal-ion-philic layer in accordance to the present invention.

FIGS. 3A and 3B are electron microscope images showing the state of the preferred embodiment of the present invention before and after charge-discharge cycling.

FIGS. 4A and 4B are electron microscope images showing the state of the prior art before and after charge-discharge cycling.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

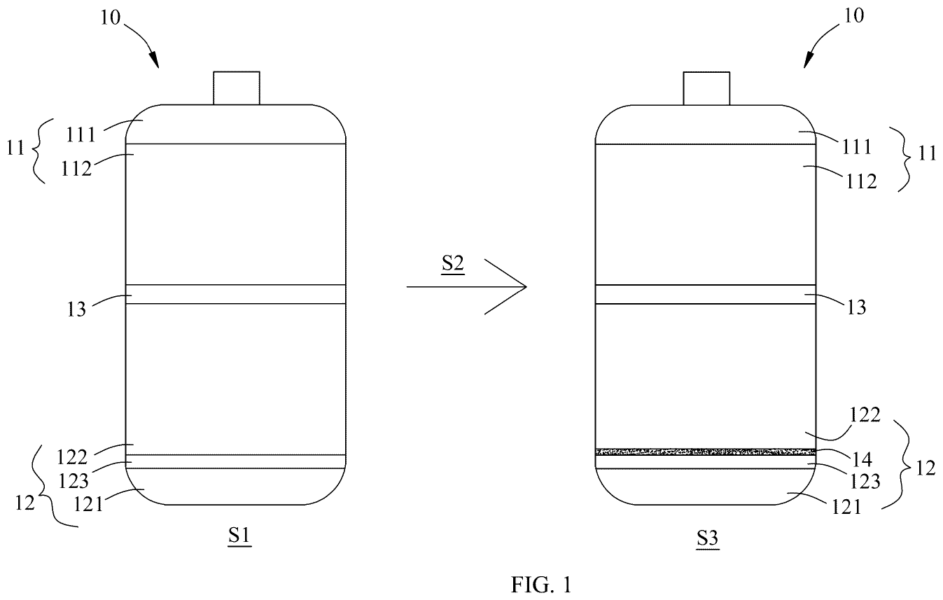

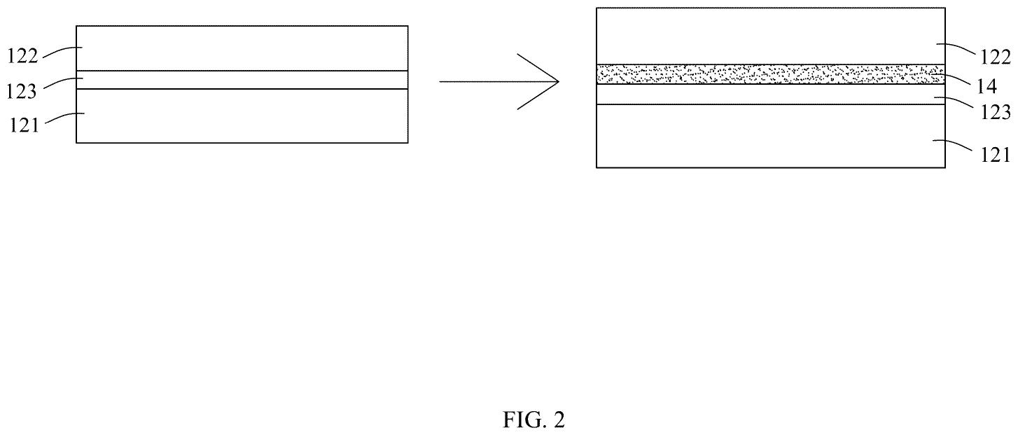

With reference to FIG. 1 and FIG. 2, which illustrate a method for enhancing the safety of a metal-ion electrochemical device according to the present invention. The method comprises the following steps:

Step 1: Providing a metal-ion electrochemical device 10, which includes at least a cathode 11, an anode 12, and a separator 13 positioned between the cathode 11 and the anode 12.

The anode 12 comprises an anode current collector 121, which is coated with an anode active material 122. A metal-ion-philic layer 123 is positioned between the anode current collector 121 and the anode active material 122.

Step 2: Charging and discharging the metal-ion electrochemical device 10.

Step 3: A metal-ion dendrite layer 14 is deposited between the anode active material 122 and the metal-ion-philic layer 123.

Preferably, the aforementioned metal-ion electrochemical device 10 in the present invention includes lithium-ion batteries, sodium-ion batteries, potassium-ion batteries, or dual-ion and multi-ion batteries composed of any of the aforementioned metal ions.

The cathode 11 of the present invention is not limited to a specific structure and may include a cathode current collector 111 and/or a cathode active material 112. Any types of the cathode current collector 111 or the cathode active material 112 applicable to different metal-ion electrochemical devices based on existing technologies falls within the scope of the present invention.

The anode active material 122 may include carbon-based compounds, silicon or its compounds or oxides, aluminum or its compounds or oxides, germanium or its compounds or oxides, lithium titanate compounds or oxides, niobium titanate compounds or oxides, or combinations thereof. Preferably, the carbon-based compounds include graphite or soft carbon, and the lithium titanate compounds include lithium titanium oxide. The anode current collector 121 includes copper foil, aluminum foil, nickel foil, stainless steel foil, indium foil, or combinations thereof.

Furthermore, in a preferred embodiment of the present invention, an electrolyte containing an electrolyte salt (not shown) is present between the cathode 11 and the anode 12 in the metal-ion electrochemical device 10. The type of electrolyte is not limited, and any electrolyte applicable to different metal-ion electrochemical devices in existing technologies falls within the scope of the present invention.

The aforementioned “metal-ion-philic” in “metal-ion-philic layer 123” refers to a material surface that exhibits affinity or wettability toward metal ions when such metal ions depositing or forming as metal. The thickness of the metal-ion-philic layer 123 is preferred to be in a range of 1˜100 nm or more preferably 1˜50 nm. Taking lithium as an example, a lithium-philic material promotes and induces the uniform deposition of lithium ions on its surface, thereby suppressing lithium dendrite formation and improving the performance and safety of the electrochemical device. The metal-ion-philic layer 123 of the present invention includes Group 2A to Group 6A elements, as well as Group 1B to Group 6B and Group 8B elements such as strontium (Sr), gallium (Ga), antimony (Sb), magnesium (Mg), calcium (Ca), barium (Ba), scandium (Sc), yttrium (Y), aluminum (Al), indium (In), thallium (Tl), germanium (Ge), tin (Sn), lead (Pb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), compounds thereof, or combinations thereof.

In step 2, in addition to charging and discharging the metal-ion electrochemical device 10 under normal voltage and current conditions, the present invention also could prevent the dendritic structure gradually piercing the separator, leading to a short circuit in the lithium-ion battery under overcharging voltage and current conditions. Under such conditions, the metal-ion dendrite layer 14 will still deposit between the anode active material 122 and the metal-ion-philic layer 123, preventing the dendrites from piercing or damaging the separator 13.

### Validation Tests

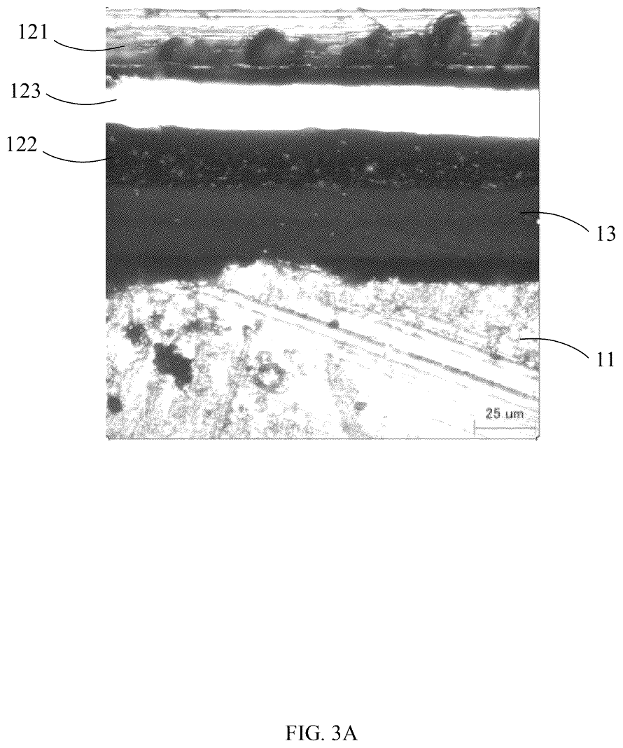

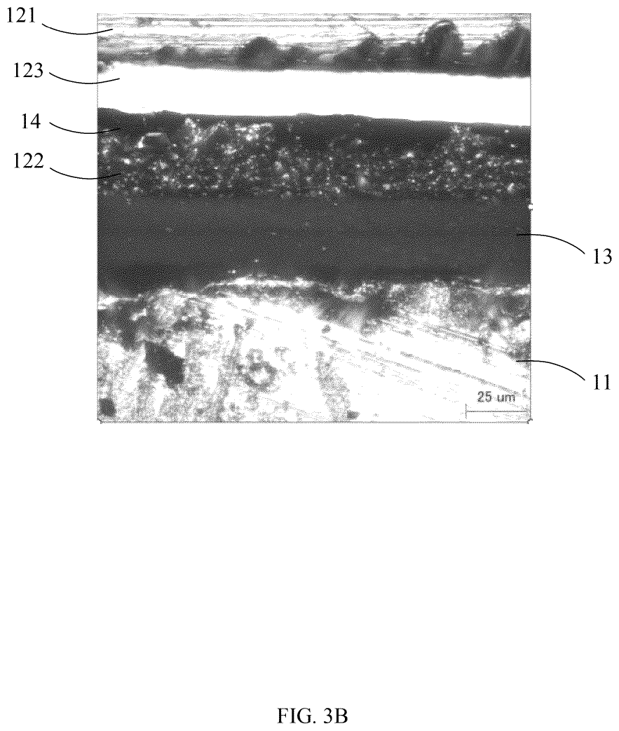

Please refer to FIGS. 3A and 3B, which illustrate an example of the present invention using a lithium-ion battery. In this example, the anode 12 consists of a copper current collector 121 (Cu Current Collector), graphite as the anode active material 122, and a metal-ion-philic layer 123 containing tin (Sn).

FIG. 3A is a cross-sectional scanning electron microscope (SEM) image of the preferred embodiment of the present invention before charge-discharge cycling. FIG. 3B is an SEM image taken after charge-discharge cycling, where the metal-ion dendrite layer 14 (lithium dendrites) is visibly deposited between the anode active material 122 and the metal-ion-philic layer 123. This deposition prevents lithium dendrites from piercing or damaging the separator 13 during charge-discharge cycles, thereby enhancing the safety of the metal-ion electrochemical device 10.

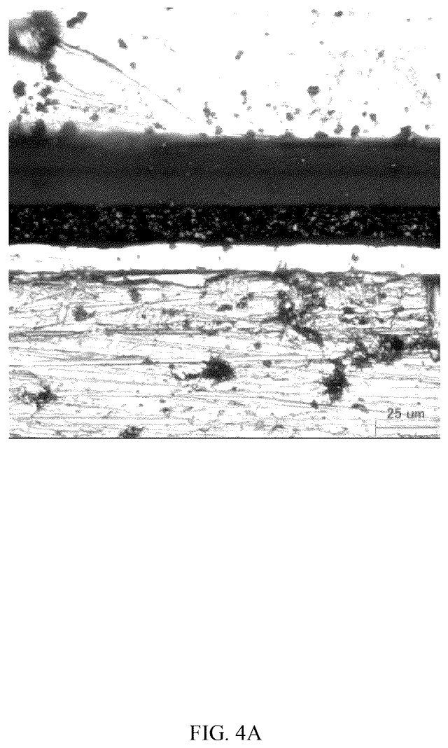

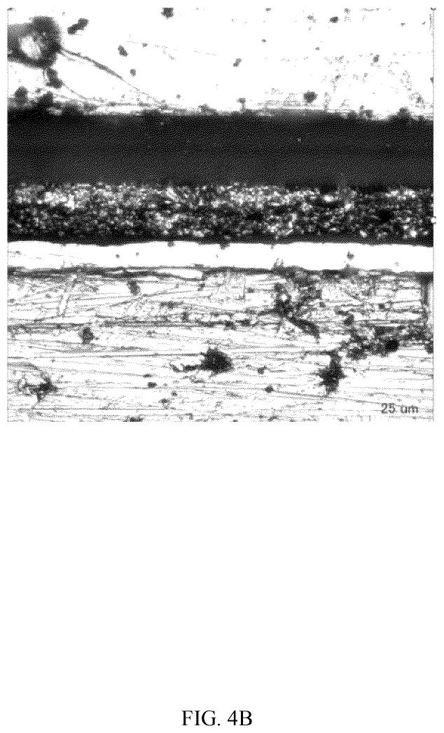

FIGS. 4A and 4B are comparative examples that do not include the metal-ion-philic layer 123. FIG. 4A is a cross-sectional scanning electron microscope (SEM) image before life cycling, while FIG. 4B shows the formation of a sharp, tippy and pointy dendrite layer at the middle position after charge-discharge cycling. This lithium dendrite structure directly contacts the separator, and with repeated charge-discharge cycles, it gradually penetrates the separator, leading to a short circuit in the lithium-ion battery.

Furthermore, in addition to the preferred embodiment described above, all other listed anode active materials 122 and metal-ion-philic layers 123 have been verified as effective in the present invention as shown in below table 1.

TABLE 1

| | | | A metal-ion dendrite |
|---|---|---|---|
| | | | layer is deposited |
| Type of metal- | | | between the anode |
| ion | | | active material and |
| electrochemical | anode active | metal-ion-philic | the metal-ion-philic |
| device | material | layer | layer. |
| lithium-ion | carbon-based | Group 2A to Group | Positive |
| batteries | compounds | 6A elements, as well | |
| | silicon or its | as Group 1B to Group | |
| | compounds or | 6B and Group 8B | |
| | oxides | elements | |
| | aluminum or its | | |
| | compounds or | | |
| | oxides | | |
| | germanium or its | | |
| | compounds or | | |
| | oxides | | |
| | lithium titanate | | |
| | compounds or | | |
| | oxides | | |
| | niobium titanate | | |
| | compounds or | | |
| | oxides | | |
| sodium-ion | carbon-based | Group 2A to Group | Positive |
| batteries | compounds | 6A elements, as well | |
| | silicon or its | as Group 1B to Group | |
| | compounds or | 6B and Group 8B | |
| | oxides | elements | |
| | aluminum or its | | |
| | compounds or | | |
| | oxides | | |
| | germanium or its | | |
| | compounds or | | |
| | oxides | | |
| | lithium titanate | | |
| | compounds or | | |
| | oxides | | |
| | niobium titanate | | |
| | compounds or | | |
| | oxides | | |
| potassium-ion | carbon-based | Group 2A to Group | Positive |
| batteries | compounds | 6A elements, as well | |
| | silicon or its | as Group 1B to Group | |
| | compounds or | 6B and Group 8B | |
| | oxides | elements | |
| | aluminum or its | | |
| | compounds or | | |
| | oxides | | |
| | germanium or its | | |
| | compounds or | | |
| | oxides | | |
| | lithium titanate | | |
| | compounds or | | |
| | oxides | | |
| | niobium titanate | | |
| | compounds or | | |
| | oxides | | |

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for enhancing the safety of a metal-ion electrochemical device, comprising the steps of:
step 1: providing a metal-ion electrochemical device, which includes at least a cathode, an anode, and a separator positioned between the cathode and the anode; wherein the anode comprises an anode current collector coated with an anode active material, and a metal-ion-philic layer is positioned between the anode current collector and the anode active material;
step 2: charging and discharging the metal-ion electrochemical device; and
step 3: depositing a metal-ion dendrite layer between the anode active material and the metal-ion-philic layer.

2. The method for enhancing the safety of a metal-ion electrochemical device as claimed in claim 1, wherein the metal-ion electrochemical device comprises a lithium-ion battery, a sodium-ion battery, a potassium-ion battery, or a dual-ion or multi-ion battery containing any of the aforementioned metal ions.

3. The method for enhancing the safety of a metal-ion electrochemical device as claimed in claim 1, wherein the anode active material comprises carbon-based compounds, silicon or its compounds or oxides, aluminum or its compounds or oxides, germanium or its compounds or oxides, lithium titanate compounds or oxides, niobium titanate compounds or oxides, or combinations thereof.

4. The method for enhancing the safety of a metal-ion electrochemical device as claimed in claim 3, wherein the carbon-based compounds comprise graphite or soft carbon, and the lithium titanate compounds comprise lithium titanium oxide.

5. The method for enhancing the safety of a metal-ion electrochemical device as claimed in claim 1, wherein the anode current collector comprises copper foil, aluminum foil, nickel foil, stainless steel foil, indium foil, or combinations thereof.

6. The method for enhancing the safety of a metal-ion electrochemical device as claimed in claim 2, wherein the anode current collector comprises copper foil, aluminum foil, nickel foil, stainless steel foil, indium foil, or combinations thereof.

7. The method for enhancing the safety of a metal-ion electrochemical device as claimed in claim 1, wherein the metal-ion-philic layer comprises Group 2A to Group 6A elements, as well as Group 1B to Group 6B and Group 8B elements.

8. The method for enhancing the safety of a metal-ion electrochemical device as claimed in claim 2, wherein the metal-ion-philic layer comprises Group 2A to Group 6A elements, as well as Group 1B to Group 6B and Group 8B elements.

9. The method for enhancing the safety of a metal-ion electrochemical device as claimed in claim 1, wherein the metal-ion-philic layer comprises strontium (Sr), gallium (Ga), antimony (Sb), magnesium (Mg), calcium (Ca), barium (Ba), scandium (Sc), yttrium (Y), aluminum (Al), indium (In), thallium (Tl), germanium (Ge), tin (Sn), lead (Pb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), compounds thereof, or combinations thereof.

10. The method for enhancing the safety of a metal-ion electrochemical device as claimed in claim 2, wherein the metal-ion-philic layer comprises strontium (Sr), gallium (Ga), antimony (Sb), magnesium (Mg), calcium (Ca), barium (Ba), scandium (Sc), yttrium (Y), aluminum (Al), indium (In), thallium (Tl), germanium (Ge), tin (Sn), lead (Pb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), compounds thereof, or combinations thereof.

11. The method for enhancing the safety of a metal-ion electrochemical device as claimed in claim 1, wherein in step 2, the metal-ion electrochemical device is charged and discharged under normal or overcharging voltage and current conditions.

12. The method for enhancing the safety of a metal-ion electrochemical device as claimed in claim 2, wherein in step 2, the metal-ion electrochemical device is charged and discharged under normal or overcharging voltage and current conditions.
